(19) United States
(12) Patent Application Publication
(10) Pub. No.: US 2002/0122116 A1
(43) Pub. Date: Sep. 5, 2002

(54) Method and device for outputting audio-visual signals

(76) Inventor: Lucas Jacobus Franciscus Geurts, Eindhoven (NL)

Correspondence Address: PHILIPS ELECTRONICS NORTH AMERICAN CORP, 580 WHITE PLAINS RD, TARRYTOWN, NY, 10591, US

(21) Appl. No.: 10/073,707

(22) Filed: Feb. 11, 2002

(30) Foreign Application Priority Data
Feb. 12, 2001 (EP) 01200476.8

(51) Int. Cl. H04N 5/225

(52) U.S. Cl. 348/207.99

(57) ABSTRACT

Method for outputting audio-visual signals on a client system (1), including: selecting (13) in an automated manner based on a predetermined criterion a selected input from a local input (12, 12′, 12″, 18) and a network input. If said network input (11) is selected as selected input: at said network input network signal data representing said audio-visual signals is received and the audio-visual signals are outputted at the output (15) in a for humans perceptible form. If the local input (12, 12′, 12″, 18) is selected as said selected input: local signal data representing said audio-visual signals is selected from a local signal database (12, 12′, 12″) and the audio-visual signals are outputted at the output (15) in a for humans perceptible form. The predetermined criterion can for example be based on a parameter relating to the amounts of local and network data or the costs of the network data.

The invention relates to a method for outputting audio-visual signals on a client system, including: selecting a selected input from a local input and a network input; if said network input is selected as said selected input: receiving at said network input network signal data representing said audio-visual signals; transmitting said data to an output and outputting at said output said audio-visual signals in a human perceptible form; and if said local input is selected as said selected input: selecting from a local signal database local signal data representing said audio-visual signals; transmitting said local signal data to said output and outputting at said output said audio-visual signals in a for humans perceptible form.

Furthermore, the invention relates to a device as in the preamble of claim 15.

The Dutch publication by R. de Graaf, “Geavanceerde muziekspeler, Music match Jukebox 5.1” in Computer Totaal, november 2000 p. 92, discloses a computer program which, when running on a client computer, is able to output audio signals stemming from a local input (for example music from data stored on the client computer system) or to output audio signals stemming from a network input (for example internet data packets transmitted from an internet server system connected to the client system). The user of the client computer system controls the switching between the network input and the local input.

An object of the invention is to provide advantageous outputting of signals. Therefore the invention provides outputting audio-visual data as described above which is characterized in that said step of selecting a selected input is performed in an automated manner based on at least one predetermined criterion.

Selecting the selected input in an automated manner based on a predetermined criterion, allows for instance to switch to a network input which provides audio-visual signals having a certain similarity with the audio-visual signals represented by the local signal data. Thus, the audio-visual signals stemming from the network are likely to be to the satisfaction of the user. Furthermore it is possible to select the network input and the local input in an alternating manner, so the user perceives a certain amount of signals stemming from the network and a certain amount of signals stemming from the local input. This allows an increase the variation of outputted audio-visual signals since the audio-visual varation of the data from the network is usually larger than the variation in the local data.

In the prior art device selecting of audio signals to his liking is a difficult task for the user of the client system, because of the huge amount and variety of audio-data available on the network. Furthermore, the amount of locally stored music is limited, so a perceiver of this local input may perceive an audio-visual piece, like music, a multiple of times, which may be experienced as annoying by the user.

The user often has to pay for the audio signals stemming from the network input. The cost may for example be associated with the information represented by the audio signal, like the movie or piece of music, or with the connection itself, for example because the user has to pay for usage of the network, for example via a subscription fee. These expenses may easily exceed a maximum amount the user wanted to spent initially.

Automated selecting according to an embodiment of the invention also allows to switch automatically to the local input if the user has spent a predetermined amount of money on the network connection thereby limiting the users expenses.

A client system according to an embodiment of the invention for outputting audio-visual signals includes: at least one network input in use communicatively connected to at least one server system, said server system in use transmitting network signal data representing said audio-visual signals to said network input; a memory means provided with local signal data representing said audio-visual signals; a switch device in a local mode communicatively connected with a first switch input contact to said memory means and in a network mode communicatively connected with a further switch input contact to at least one network input, said switch device further having a switch output contact; an output communicatively connected to said switch output contact, which output in use outputs said audio-visual signals in a for humans perceptible form. According to an embodiment of the invention such a device is characterized in that said switch device is arranged to be controlled by a control device for automatically switching said switch device depending on at least one predetermined criterion.

The invention also relates to a computer program that contains code portions for performing steps of a method according to the invention when running on a computer system.

Particular embodiments of the invention are set forth in the dependent claims.

Further objects, elaborations, modifications, effects and details of the invention appear from the following description, in which reference is made to figures in the attached drawing.

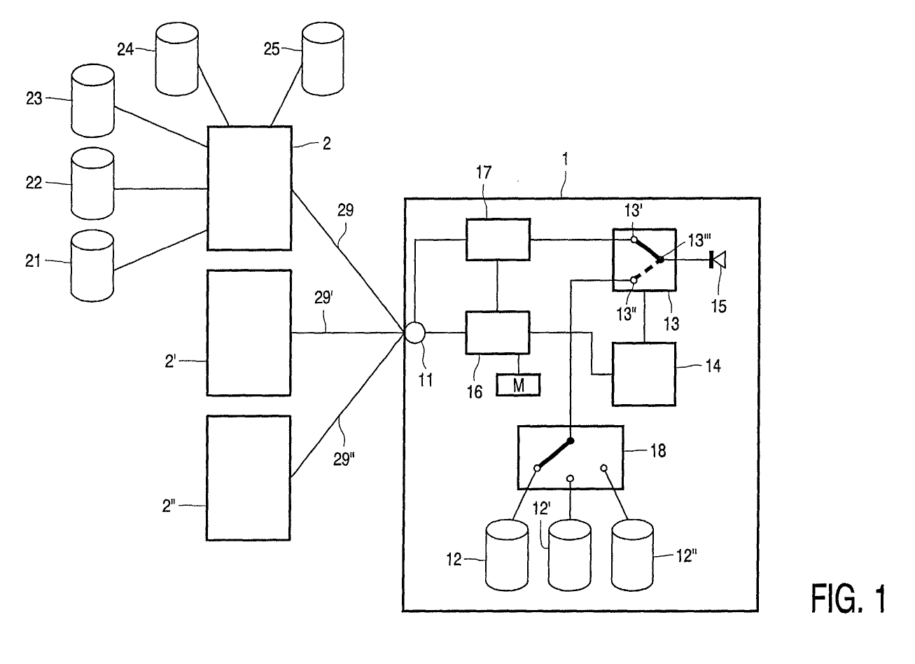

FIG. 1 diagrammatically shows an example of an embodiment of a system for outputting audio-visual signals according to the invention.

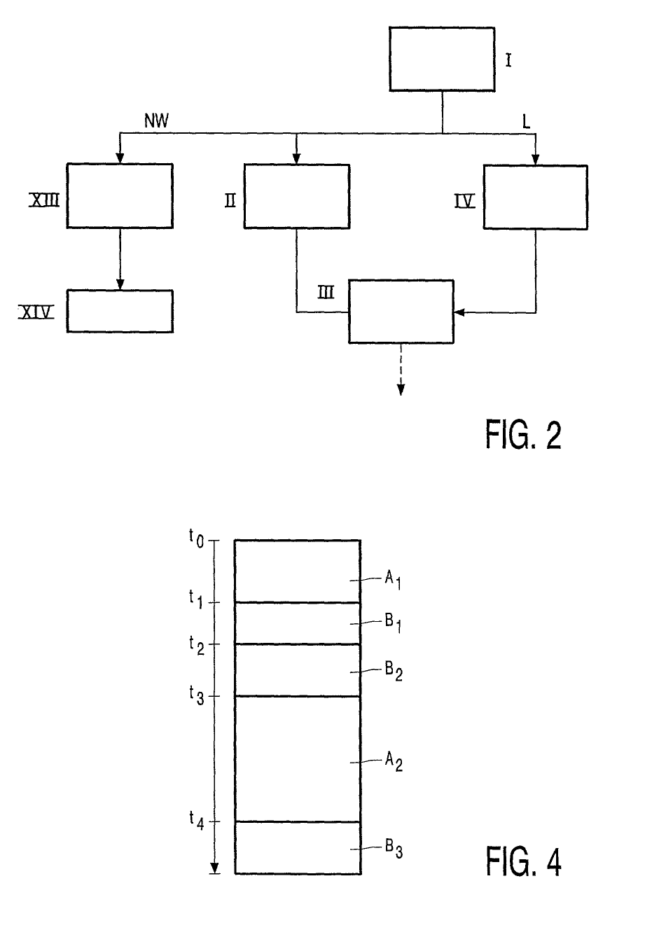

FIG. 2 diagrammatically shows steps of a first example of a method according to the invention.

FIG. 3 diagrammatically shows steps of a second example of a method according to the invention.

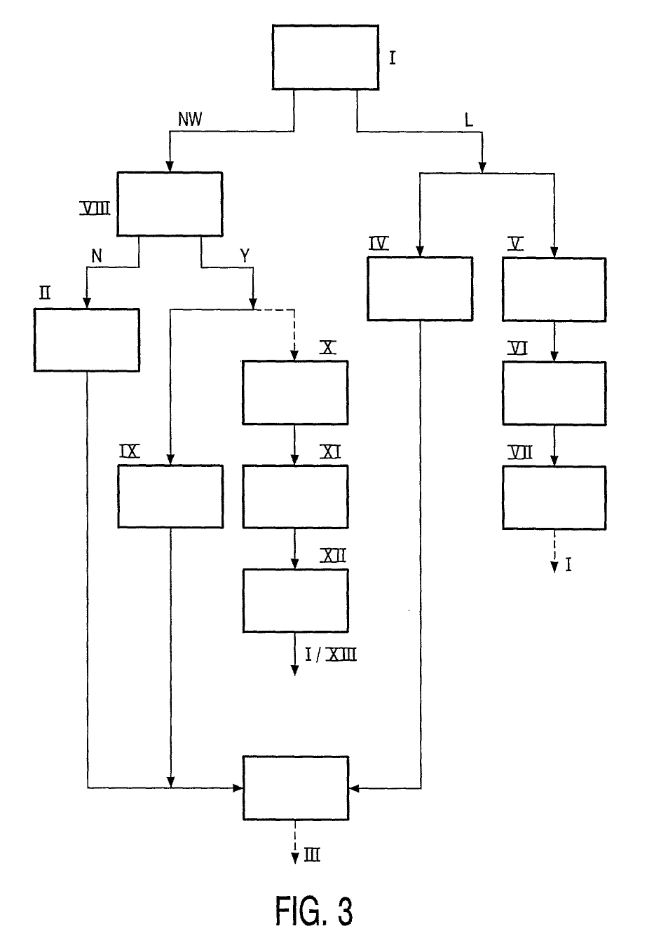

FIG. 4 shows a sequence of audio-visuals signals outputted in accordance with a method according to an embodiment of the invention.

Referring to FIG. 1, a system 1 for outputting audio-visual signals according to an embodiment of the invention includes a network input 11 which is connected to server systems 2, 2′, 2″. The system 1 further includes local signal databases 12, 12′, 12″ provided with local signal data representing audio-visual signals. Audio-visual signals may represent sound, or images or both. These signals may be for example be audio signals, such as music, or video signals, such as movies, or a combination such as music clips. Connected to the network input and the local signal databases 12, 12′, 12″ is a switch device 13 in this embodiment having a first input contact 13′, a further input contact 13″ and an output contact 13′″.

As shown in FIG. 2, a method performed by the device of FIG. 1 is initiated with an input selection step I. In this input selection step I, the switch device 13 selects a selected input from the network (NW) input and a local (L) input which in the device shown in FIG. 1 are the local signal databases 12, 12′, 12″. At the selected input signal data is received in reception steps II or IV. The reception step is a network reception step II if the network input 11 is the selected input. If the selected input is the local input, the reception step is a local signal data reception step IV. The audio-visual signals represented by the signal data received in reception step II,IV are outputted in an output step III. In the system 1, this output step III is performed by an output device 15. This output device 15 may output the audio-visual signals represented by the data in any type suitable for human perception, such as sound or images or both. The output device 15 may be of any type appropriate for the specific signals, like for example a loudspeaker for sound signals and a computer monitor or a television set for visual signals.

Switch device 13 is controlled by control device 14. This control device 14 automatically switches switch device 13 based on a predetermined criterion. This predetermined criterion may be any suitable criterion.

The criterion may for instance be based on the type of audio-visual signals represented by the local signal data. The type might be stored in a data field in the local signal database. For example, if the local signal data represent audio signals, the data field may indicate the type of music and have values like: “classic”, “country” or “rock and roll”. If the local signal data represents for example movies, the data field may indicate the type of movie and may have values like: “action”, “science-fiction” or “comedy”. If the predetermined criterion is based on the type of signals, the local input may be selected if the type of network signal data does not match the type of the local signal data and the network input may be selected if the type of network signal data does match the type of the local signal data.

If the switching criterion is based on the type of local signal, it may be based on the type of local signal data stored on the client system. Thereby, it is likely that the general preferences of the user are satisfied. So, if for example the local signal data represents only classical music, jazz music and Irish folk songs, it is likely that the user does like these three types of music most. The predetermined criterion may also be based on the type of audio-visual signals being outputted at a certain moment. Thereby, it is likely that the current preferences of the user are satisfied. If for example the user is at a certain moment listening to the 5^{th} symphony of Beethoven while the local signal data stored on the client system represent classical music, jazz music and Irish folk songs, it is likely that at that certain moment the user prefers classical music above Irish folk songs.

The predetermined criterion might further be based on the amount of money spent on the audio-visual signals stemming from the server system. The expenses may for example be associated with the information represented by the audio signal, like the movie or piece of music, or with the connection itself, for example because the user has to pay for usage of the network, for example via a subscription fee. For example, since the user often has to pay for the network input, the control device 14 may be set to turn switch device 13 from network input to local input if the user of the system 1 has spent a certain amount of money on the network input. Hereby, unwanted expenses may be prevented.

The predetermined criterion may also be based on the amount of local signal data and/or the amount of network data received, transmitted or outputted as audio-visual signals. For example, as a switching criterion the ratio of local signal data and network data can be used. It is likewise possible to use as a criterion the time during which audio-visual signals from local signal data are outputted and the time during which signals from network data are outputted, which may for example result in a sequence of audio-visuals signals as is shown in FIG. 4.

According to the example of FIG. 4, first the local input is the selected input and a piece Al of music from a local signal database is played from start time t₀ until time t₁. Thereafter, the network input 11 is selected and pieces B1,B2 from the server systems 2, 2′, 2″ are outputted from time t₁ until time t₃. At time t₃ the ratio between outputted local signal data and outputted network data is such that the switching criterion is satisfied and the switch 13 is again switched to the local input. From time t₃ a piece of local music A3 is played until the ratio satisfies the switching criterion at time t₄ and the network input 11 is selected, where after a piece of music B3 is outputted which stems from one of the server systems 2, 2′, 2″.

Usage of a switching criterion based on the ratio of the amount of outputted local signal data and the amount of outputted network data guarantees the user of the system 1 a certain amount of audio-visual signals stemming from local signal data known (and presumably appreciated) by the user and a certain amount of new audio-visual signals stemming from the network data. However, the invention is not limited to these examples of predetermined switching criteria. Other criteria should be apparent to the worker in the art, for example the number of repetitions of outputting the same audio-visual signals may be used as a switching criterion. Furthermore, a combination of criteria may be used as well. For example, a basic criterion may be the ratio between network data (time) and local data (time) and an overriding criterion may be an expenditure limit set by the user. Thus, irrespective of the basic criterion automatic switching to the local input may be performed if the user has spent a certain amount of money. As another example, automatic switching from the local input to the network input (or vice versa) may be performed irrespective of a basic criterion if the user has perceived audio-visual signals represented by the local (or the network) signal data for a certain overall maximum time.

A system of the type as shown in FIG. 1 is able to perform by way of example a method shown in FIG. 3. In this method, if the local input is the selected input, a second network reception step VI may be performed simultaneously with the local reception step IV. In the client system shown in FIG. 1, the control device 14 is connected to a search and download device 16 which performs the network reception steps II and VI.

User preferences indicating the audio-visual preferences of the user are stored in memory means M of this search and download device 16. The search and download device 16 searches the server systems 2, 2′, 2″ connected to the system I for network data which satisfy the user preferences thereby performing a search step V before the network reception step VI. The user's preferences may be stored in the memory means M by the user or be determined automatically based on the type of local signal data, as is explained above. If such network data is found, the respective network data are transmitted to system 1 and stored in a buffer memory means 17 in storing step VII. As mentioned, steps V,VI and VII may be performed while the local input is the selected input. If thereafter selecting step I is performed and the switch device 13 is switched from local input to network input 11 the data stored in buffer means 17 is used as the network signal data in a buffer output step IX if data is present in the buffer means (decision step VIII). This allows the user to perceive audio-visual signals stemming from the network immediately after switching to the network input without waiting until network data corresponding to his preferences is found. While the data stored in buffer means 17 is used in buffer output step IX and output step III, a network reception step XI and storing step XII, and optionally a search step X, similar to steps V-VII may be performed, whereby new network data is searched and downloaded with device 16. Hereby, a substantially continuous outputting of audio-visual signals from the network input which correspond to the user preferences is guaranteed.

It is likewise possible to provide a system for outputting audio-visual signals without such search and download possibilities, for example a system in which the control device controls the switch device 13 only and wherein device 16 and buffer 17 are not present. Furthermore it is also possible to use just a search device instead of a search and download device. Such a device searches for server systems transmitting network data which satisfy preferences of the user, but outputs the audio-visual signals directly instead of storing these data in buffer means. The search device may also be implemented on one or more of the server systems 2, 2′, 2″ instead of on the system 1. The server system will then search in the databases connected to the server system for data satisfying the stored user preferences and transmit these data to system 1, where they may be outputted substantially immediately or may be stored in buffer means 17 for outputting at some time after receiving.

Server systems 2, 2′, 2″ transmit network data to the system 1. The network data may be selected from a number of databases 21-25 provided with the network data. In the example of FIG. 1 databases 21-25 are connected to server system 2. Server systems 2′, 2″ too are connected to such databases, however for the sake of simplicity this is not shown in FIG. 1. The databases 21-25 may be part of the same physical system as the server system 2 or may be placed in different physical devices connected to server system 2. These databases may be at remote locations and may be collections of companies or collections of private persons, for example the collections of a community of private persons with the same preferences. The invention is not limited to the shown number of server systems, neither to the shown number of databases connected to the server systems nor the shown number of local signal databases. Furthermore, databases may be connected to the system 1 with an indirect connection, for example in an internet network architecture.

Besides network signal data representing the audio-visual signals, metadata may be received in metadata reception step XIII and outputted in metadata output step XIV. In the system shown in FIG. 1 the metadata is received at the network input 11 and outputted with the same output 15 as the audio-visual signals. However a different output may be used, for example the meta data may be displayed on a screen of instance a computer monitor, while audio signals are outputted with a loudspeaker.

The metadata may comprise additional information like newsheadlines or information about the network signal data or the audio-visual signals, like a song title or a movie title. The metadata could for example also be messages from the server systems 2, 2′, 2″ to the user of system 1 or advertising messages from the owners of the databases 21-25. If the metadata includes pricing and selling information related to the audio-visual signals, the user of the system may order a copy of the perceived audio-visual signals, for example, in the case of music, a Compact Disk or MP3 file, or in the case of movies a Digital Versatile Disk (DVD) or a Video cassette. The metadata may also include an indication of a beginning and an end of a transmission of coherent signal data, like an indication of the beginning and the ending of a movie or a piece of music, which enables postponing a switching operation if the switching criterion is satisfied, until all the audio-visual signals represented by the coherent signal data are outputted by the output device 15.

Network input 11 is connected to server systems 2, 2′, 2″ via connections 29, 29′, 29″. The connections may be of any suitable kind, like for example a wireless connection, a cable connection or an optical fibre. The server system may be of any suitable type. However, it is advantageous if the server system is a World Wide Web server, communicating with the system 1 via the TCP/IP protocol since this allows server system and system 1 to communicate via standard software included in most operating systems.

The system 1 includes local signal databases 12, 12′, 12″. These databases are stored in suitable memory means. These memory means may be of various different types, for example database 12 may be stored on a Compact Disk, while database 12′ may be stored as a collection of MP3 files on a hard-disk and database 12″ may be stored on a video recorder which may communicate in a wireless manner with the system 1. A selection device 18 is arranged for selecting local signal data from databases 12, 12′, 12″.

The switch device 13 shown in FIG. 1 is able to switch between two different input contacts 13′, 13″, however it is likewise possible to provide a switch 13 which is not only able to select between the local input and the network input but is further able to select a specific one of the local signal databases and/or a specific one of the network databases 21-25 or one of the server systems 2, 2′, 2″. Such a switch device 13 would at least partly incorporate selection device 18 and, in the embodiment of FIG. 1, could have three local input contacts, and/or a plurality of network input contacts. Furthermore the network input may be provided with a switch which selects one of the server systems 2, 2′, 2″.

The invention is not limited to application in a physical system but can likewise be applied in a logical system of a more abstract kind. For example, the invention may be implemented in software code instructions loaded in a device able to perform the code instructions. This may for example be a general purpose computer which when running the code instruction performs the functions of the devices described above. Furthermore, the invention is not limited to a method as such but can likewise be implemented in a computer program which contains code portions for performing steps of a method according to the invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measurs are recited in mutually different dependent claims does not indicate that a combination of these measures cannot be used to advantage.

1. A method for outputting audio-visual signals on a client system, including:
selecting (I) a selected input from at least one local input (12, 12′, 12″, 18) and at least one network input (11);
if said network input (11) is selected as said selected input:
receiving (II) network signal data representing said audio-visual signals at said network input;
outputting (III) at an output (15) said audio-visual signals in a for humans perceptible form;
and if said local input (12, 12′, 12″, 18) is selected as said selected input:
selecting (IV) from a local signal database local signal data representing said audio-visual signals;
outputting (III) at said output (15) said audio-visual signals in a for humans perceptible form; characterised in that,
said step of selecting (I) a selected input is performed in an automated manner based on at least one predetermined criterion.

2. A method as is claimed in claim 1, wherein at least one of said at least one predetermined criterion is based on a property of said local signal data

3. A method as is claimed in claim 2, wherein if said local input is selected said predetermined criterion is based on a property of said audio-visual signals being outputted.

4. A method as is claimed in claim 1, wherein at least one of said at least one predetermined criterion is based on a predetermined relation between a parameter related to the amount of transmitted local signal data and a parameter related to the amount of transmitted network signal data.

5. A method as is claimed in claim 4, wherein said predetermined relation is the ratio of the amount of transmitted local signal data and the amount of transmitted network signal data.

6. A method as claimed in claim 1, wherein at least one predetermined criterion is based on a parameter related to the costs of said network signal data.

7. A method as is claimed in claim 4, wherein at least one first predetermined criterion based on a predetermined relation between a parameter related to the amount of transmitted local signal data and a parameter related to the amount of transmitted network signal data based on a parameter related to the costs of said network signal data is used and at least one second criterion and wherein irrespective of said first criterion said input (12, 12′, 12″, 18) is selected as said selected input as soon as said at least one second predetermined criterion is satisfied.

8. A method as claimed in claim 1, wherein if said local input (12, 12′, 12″, 18) is selected as said selected input further said receiving of said network signal data is performed simultaneously and said network signal data is stored in a buffer memory means (17) as buffered data.

9. A method as is claimed in claim 8 wherein a second step of selecting (I) a selected input is performed after said local input (12, 12′, 12″, 18) is selected and if in said second step of selecting (I), said network input (11) is selected as said selected input said buffered data is used (IX) for providing network signal data.

10. A method as claimed in claim 1, wherein simultaneously with said step of receiving network signal data (II) a metadata reception step (XIII) of receiving metadata is performed, and said method further including a metadata output step (XIV) of outputting said metadata in a for humans perceptible form.

11. A method as claimed in claim 10, wherein said metadata includes pricing data representing pricing and selling information relating to said audio-visual signals.

12. A method as claimed in claim 10, wherein said metadata is displayed on a visual output means.

13. A method as is claimed in claim 1, wherein said network signal data is obtained from a server computer system (2, 2′, 2″) which is communicatively connected to said network input (11) and said method is performed on a client computer system.

14. A method as claimed in claim 1, wherein said audio-visual signals are audio signals.

15. A client system for outputting audio-visual signals including:
at least one network input (11) in use communicatively connected to at least one server system (2, 2′, 2″), said server system (2, 2′, 2″) in use transmitting network signal data representing said audio-visual signals to said network input (11);
a memory means (12, 12′, 12″) provided with local signal data representing said audio-visual signals;
a switch device (13) in a local mode communicatively connected with a first switch input contact (13′) to said memory means (12, 12′, 12″) and in a network mode communicatively connected with a further switch input contact (13″) to at least one network input (11), said switch device (13) having a switch output contact (13′″);
an output device (15) communicatively connected to said switch output contact (13′″), which output device (15) in use outputs said audio-visual signals in a for humans perceptible form; characterised in that,
said switch device (13) is arranged to be controlled by a control device (14) for automatically switching said switch device (13) depending on at least one predetermined criterion.

16. A client system as claimed in claim 15, wherein at least one of said at least one predetermined criterion is based on a property of said local signal data.

17. A client system as claimed in claim 16, wherein if said switch device (13) is in said local mode said predetermined criterion is based on a property of said audio-visual signals being outputted.

18. A client system as claimed in claim 15, wherein at least one predetermined criterion is based on a predetermined relation between a parameter related to the amount of transmitted local signal data and a parameter related to the amount of transmitted network signal data.

19. A client system as is claimed in claim 18, wherein said predetermined relation is the ratio of the amount of transmitted local signal data and the amount of transmitted network signal data.

20. A client system as is claimed in claim 15, wherein at least one predetermined criterion is based on a parameter related to the costs of said network signal data.

21. A client system as is claimed in claim 18, wherein at least one first predetermined criterion based on a predetermined relation between a parameter related to the amount of transmitted local signal data and a parameter related to the amount of transmitted network signal data and at least one second criterion based on a parameter related to the costs of said network signal data are valid and wherein said control device (14) is arranged to switch said switch device (13) to said local input as soon as said at least one second predetermined criterion is satisfied, irrespective of said first criterion.

22. A client system as is claimed in claim 15, wherein said network input (11) is connected to a buffer memory (17) for storing network signal data as buffered data, said buffer memory (17) having a buffer output connected to said switch device (13).

23. A client system as is claimed in claim 15, further including a selection device (18) for selecting local signal data from said local signal database, said selection device (18) being communicatively connected to said local signal database (12, 12′, 12″) and to said switch device (13).

24. A client system as is claimed in claim 15, further including a network selection device (16) for selecting one of a plurality of server systems (2, 2′, 2″) said selection device being communicatively connected to said at least one server system (2, 2′, 2″) and to said switch device (13).

25. A client system as is claimed in claim 15, wherein said at least one server system (2, 2′, 2″) in use further transmits metadata and said client system further includes a metadata output device (15) communicatively connected to said network input (11).

26. A client system as is claimed in claim 20, wherein said metadata represents pricing and selling information about said audio-visual signals.

27. A client system as is claimed in claim 25, wherein said metadata output device (15) is a visual display device.

28. A computer program for running on a computer system, characterised in that the computer program contains code portions for performing steps of a method as is claimed in claim 1 when running on a computer system.

29. A data carrier containing data representing a computer program as is claimed in claim 28.
